(19) United States
(12) Patent Application Publication
(10) Pub. No.: US 2007/0173616 A1
(43) Pub. Date: Jul. 26, 2007

(54) Resin composition

(75) Inventors: Kazuo Sugiyama, Higashihiroshima-shi (JP); Kohei Shiraishi, Higashihiroshima-shi (JP); Hiroyuki Shirahama, Higashihiroshima-shi (JP); Toru Yano, Hiroshima-shi (JP)

Correspondence Address: SUGHRUE MION, PLLC, 2100 PENNSYLVANIA AVENUE, N.W., SUITE 800, WASHINGTON, DC, 20037, US

(73) Assignees: Kinki University; NISHIKAWA RUBBER CO., LTD.

(21) Appl. No.: 11/488,009

(22) Filed: Jul. 18, 2006

(30) Foreign Application Priority Data
Jul. 19, 2005 (JP) P. 2005-209019

(51) Int. Cl. C08G 69/48

(52) U.S. Cl. 525/419

(57) ABSTRACT

The present invention provides a resin composition comprising poly(L-lactic acid), a crystallization accelerator, a flexibility-imparting agent, and a compatibilizing agent.

### FIELD OF THE INVENTION

The present invention relates to a resin composition. More particularly, the invention relates to a resin composition excellent in heat resistance and impact resistance.

### BACKGROUND OF THE INVENTION

Poly(lactic acid) has been used as a material for (biodegradable) resin compositions. However, poly(lactic acid) generally has the property of being rigid and poor in impact resistance and, hence, tends to be usable in limited applications.

A technique for improving such property is disclosed, e.g., in patent document 1. This technique comprises incorporating an impact modifier comprising lactic acid units and a polyester unit into a poly(hydroxycarboxylic acid) to thereby obtain a polyester composition which is less apt to suffer bleeding, retains intact flexibility and transparency, and has impact resistance.

Patent Document 1: JP-A-2001-335623

However, in the technique described above, the impact modifier to be mixed with a poly(hydroxycarboxylic acid) has insufficient compatibility and the effect thereof is low when the proportion thereof is low. It is therefore necessary to heighten the proportion of the impact modifier in the polyester composition in order to obtain a sufficient impact resistance-improving effect. On the other hand, the impact modifier has high flexibility and, hence, the technique has the following problem. Increasing the proportion of the impact modifier improves flexibility but simultaneously lowers the softening temperature and this results in poor heat resistance.

### SUMMARY OF THE INVENTION

The invention has been made in order to overcome the problems described above.

An object of the invention is to provide a resin composition excellent in heat resistance and impact resistance.

Other objects and effects of the invention will become apparent from the following description.

The present inventor made extensive investigations. As a result, that object was found to be accomplished by employing the following constitutions. The invention has been thus achieved.

The invention provides the following.
(1) A resin composition comprising poly(L-lactic acid), a crystallization accelerator, a flexibility-imparting agent, and a compatibilizing agent.
(2) The resin composition as described in (1) above, wherein the crystallization accelerator is a D-lactic acid/starch copolymer resin.
(3) The resin composition as described in (1) above, wherein the flexibility-imparting agent is polycaprolactone.
(4) The resin composition as described in (1) above, wherein the compatibilizing agent is a poly(L-lactic acid)/poly(butylene succinate) block copolymer resin.

The resin composition of the invention can be excellent in heat resistance and impact resistance because it comprises poly(L-lactic acid), a crystallization accelerator, a flexibility-imparting agent, and a compatibilizing agent.

### DETAILED DESCRIPTION OF THE INVENTION

The resin composition of the invention will be explained below in detail.

The resin composition according to the invention is characterized by comprising poly(L-lactic acid), a crystallization accelerator, a flexibility-imparting agent, and a compatibilizing agent.

The poly(L-lactic acid) contained in the invention is not particularly limited. Examples thereof include one obtained by adding a polymerization catalyst to a mixture of 90% fermentation lactic acid and a starch and subjecting the mixture to dehydrating polymerization, commercial poly(lactic acid) products (e.g., Lacea H-100J, manufactured by Mitsui Chemicals, Inc.), and poly(lactic acid) containing a heat-resistant nanocomposite filler. Any of these may be used.

The crystallization accelerator to be used in the invention is not particularly limited. Preferred examples thereof include poly(D-lactic acid) and D-lactic acid/starch copolymer resins. Although any of these may be used, D-lactic acid/starch copolymer resins, which contain a saccharide, are more preferred.

The weight-average molecular weight of the crystallization accelerator is not particularly limited. However, it preferably is in the range of 1,000-2,000,000. When the weight-average molecular weight of the crystallization accelerator is lower than 1,000, it forms a eutectic and attains an increased crystallization rate. In this case, however, the resin may be syrupy and difficult to handle. When the weight-average molecular weight thereof exceeds 2,000,000, this crystallization accelerator has a high melt viscosity and there may be cases where it is difficult to take out after polymerization.

The amount of the crystallization accelerator to be added is not particularly limited. However, the amount thereof is preferably 1-50 parts by weight, more preferably 2-15 parts by weight, per 100 parts by weight of the poly(lactic acid). When the amount thereof is smaller than 1 part by weight, there may be cases where a remarkable crystallization-accelerating effect is not obtained and the poly(lactic acid) does not have improved heat resistance. When the crystallization accelerator is added in an amount larger than 50 parts by weight, this may result in an increased resin cost under present circumstances although the heat resistance is improved.

The flexibility-imparting agent to be used in the invention is not particularly limited. The flexibility-imparting agent may be any biodegradable resin having a melting point or softening point not higher than the melting point or softening point of poly(lactic acid). Examples thereof include commercial resins such as polycaprolactone, caprolactone/butylene succinate copolymers, poly(butylene adipate-terephthalate), poly(butylene succinate), adipate-modified poly(butylene succinate) resins, carbonate-modified poly(butylene succinate) resins, poly(ethylene terephthalate-succinate), poly(ethylene succinate), and poly(hydroxybutyrate)s.

The amount of the flexibility-imparting agent to be added can be appropriately selected according to the intended use of the resin composition.

The amount of the flexibility-imparting agent to be added is not particularly limited. However, it preferably is 1-100 parts by weight, more preferably 2-15 parts by weight, per 100 parts by weight of the poly(lactic acid). When the amount thereof is smaller than 1 part by weight, there may be cases where the addition of the flexibility-imparting agent is not remarkably effective in improving the impact resistance of the poly(lactic acid). When the flexibility-imparting agent is added in an amount larger than 100 parts by weight, there may be cases where the sea-island structure in the resin composition is reversed, resulting in reduced heat resistance, although the impact resistance is improved.

The compatibilizing agent to be used in the invention is not particularly limited. However, it preferably is a polymer obtained by the block copolymerization of poly(D- or L-lactic acid) or a D- or L-lactic acid/starch copolymer resin with a biodegradable resin having a melting point or softening point not higher than that of poly(lactic acid). The biodegradable resin is, for example, polycaprolactone, a poly(butylene adipate-terephthalate), an adipate-modified poly(butylene succinate) resin, or the like. For the copolymerization may be used a dehydrating condensation reaction in which the resins are heated and melted together under reduced pressure or a crosslinking reaction in which a compound having two or more isocyanate or epoxy groups is used.

The amount of the compatibilizing agent to be added is not particularly limited. However, the amount thereof is preferably 1-30 parts by weight, more preferably 5-30 parts by weight, per 100 parts by weight of the poly(lactic acid). When the amount thereof is smaller than 1 part by weight, there may be cases where the addition of the compatibilizing agent is not remarkably effective in improving the impact resistance of the poly(lactic acid). Even when it is added in an amount larger than 30 parts by weight, there may be cases where the effect of improving impact resistance is not enhanced any more. Also, there may be cases where tensile strength and heat resistance decrease.

### EXAMPLES

The invention will be illustrated in greater detail by reference to the following Examples, but the invention should not be construed as being limited thereto.

### Example 1

(a) Mixing of Poly(Lactic Acid), Crystallization Accelerator, Flexibility-Imparting Agent and Compatibilizing Agent:

A hundred parts by weight of poly(L-lactic acid) (Lacea H-100J, manufactured by Mitsui Chemicals, Inc.), 5 parts by weight of a D-lactic acid/0.1 wt % starch copolymer resin (crystallization accelerator), 20 parts by weight of a poly(L-lactic acid)/poly(butylene succinate) block copolymer resin (compatibilizing agent), and 5 parts by weight of polycaprolactone (flexibility-imparting agent 2) (Placcel H-7, manufactured by Dicel Chemical Industries, Ltd.) were weighed out each in a pellet form. These ingredients were premixed together in a bag made of PE. The resultant mixture was kneaded with kneader SIKR, manufactured by Kurimoto, Ltd., extruded into strands, cooled on a conveyor, and then palletized.

(b) Injection Molding of Resin Mixture:

The mixture pellets produced in (a) above were molded into #1 tensile test pieces in accordance with JIS K7113 and rod-shaped test pieces for measuring deformation under load (100 mm×10 mm×4 mm), each using SAV-30, manufactured by Sanjo Seiki Co., Ltd. The molding temperatures in a screw upstream part, a screw downstream part, and the nozzle were set at 170° C., 175° C., and 180° C., respectively. Furthermore, the experiment was conducted at a mold temperature of 110° C. (value measured on the moving platen side, with the set mold temperature being 120° C.) and a cooling time of 120 seconds.

The test pieces obtained were examined for heat deformation temperature in accordance with JIS K7191-2 and for maximum tensile strength and elongation at break in accordance with JIS K7113. The test pieces were further examined for Izod impact strength in accordance with JIS K7110. The results obtained are shown in Table 1.

### Example 2

Test pieces were produced in the same manner as in Example 1, except that the amount of polycaprolactone was changed to 10 parts by weight. Thereafter, the test pieces were examined for heat deformation temperature, maximum tensile strength, elongation at break, and impact strength each in the same manner as in Example 1.

The results obtained are shown in Table 1.

### Example 3

Test pieces were produced in the same manner as in Example 2, except that the polycaprolactone was replaced by 5 parts by weight of poly(butylene adipate-terephthalate) (flexibility-imparting agent 1) (Ecoflex FBX 7011, manufactured by BASF AG). The test pieces were examined for heat deformation temperature, maximum tensile strength, elongation at break, and impact strength each in the same manner as in Example 1.

The results obtained are shown in Table 1.

### Example 4

Test pieces were produced in the same manner as in Example 1, except that the polycaprolactone was replaced by 10 parts by weight of poly(butylene adipate-terephthalate). The test pieces were examined for heat deformation temperature, maximum tensile strength, elongation at break, and impact strength each in the same manner as in Example 1.

The results obtained are shown in Table 1.

### Comparative Example 1

Test pieces were produced in the same manner as in Examples 1 to 4, except that 100 parts by weight of poly(L-lactic acid) only was used and the mold temperature was changed to 30° C. The test pieces were examined for heat deformation temperature, maximum tensile strength, elongation at break, and impact strength each in the same manner as in Examples 1 to 4.

The results obtained are shown in Table 1.

### Comparative Example 2

Test pieces were produced in the same manner as in Examples 1 to 4, except that the composition was changed as shown below. The test pieces were examined for heat deformation temperature, maximum tensile strength, elongation at break, and impact strength each in the same manner as in Examples 1 to 4.

| | | |
|---|---|---|
| Poly(L-lactic acid) | 100 | parts by weight |
| D-Lactic acid/0.1 wt % starch copolymer resin | 5 | parts by weight |

The results obtained are shown in Table 1.

### Comparative Example 3

Test pieces were produced in the same manner as in Examples 1 to 4, except that the composition was changed as shown below. The test pieces were examined for heat deformation temperature, maximum tensile strength, elongation at break, and impact strength each in the same manner as in Examples 1 to 4.

| | | |
|---|---|---|
| Poly(L-lactic acid) | 100 | parts by weight |
| D-Lactic acid/0.1 wt % starch copolymer resin | 5 | parts by weight |
| Poly(L-lactic acid)/poly(butylene succinate) | 20 | parts by weight |
| block copolymer resin | | |

The results obtained are shown in Table 1.

TABLE 1

| | Example | Example | Example | | Comparative | Comparative | Comparative |
|---|---|---|---|---|---|---|---|
| | 1 | 2 | 3 | Example 4 | Example 1 | Example 2 | Example 3 |
| Poly(L-lactic acid) | 100 | 100 | 100 | 100 | 100 | 100 | 100 |
| Crystallization accelerator | 5 | 5 | 5 | 5 | — | 5 | 5 |
| Compatibilizing agent | 20 | 20 | 20 | 20 | — | — | 20 |
| Flexibility-imparting agent 1 | — | — | 5 | 10 | — | — | — |
| Flexibility-imparting agent 2 | 5 | 10 | — | — | — | — | — |
| Mold temperature (° C.) | 110 | 110 | 110 | 110 | 30 | 110 | 110 |
| Cooling time (min) | 2 | 2 | 2 | 2 | 0.5 | 2 | 2 |
| Tensile strength (MPa) | 41 | 41 | 37 | 41 | 60 | 36 | 47 |
| Elongation (%) | 2.7 | 2.4 | 2.1 | 2.2 | 2.2 | 1.5 | 2.4 |
| Izod impact strength (kJ/m²) | 7.1 | 7.9 | 5.8 | 8.8 | 3 | 1.5 | 4.9 |
| Heat deformation temperature (° C.) | 112 | 80 | 105 | 66 | 52 | 131 | 116 |

As apparent from Table 1, the resin compositions of Examples 1 to 4 according to the invention are excellent in heat resistance and impact resistance.

Molded articles obtained from the resin composition of the invention are usable as automotive parts, parts for domestic electrical appliances, and general industrial materials.

While the present invention has been described in detail and with reference to specific embodiments thereof, it will be apparent to one skilled in the art that various changes and modifications can be made therein without departing from the spirit and scope thereof.

This application is based on Japanese Patent Application No. 2005-209019 filed Jul. 19, 2005, and the contents thereof are herein incorporated be reference.

What is claimed is:

1. A resin composition comprising poly(L-lactic acid), a crystallization accelerator, a flexibility-imparting agent, and a compatibilizing agent.

2. The resin composition of claim 1, wherein the crystallization accelerator is a D-lactic acid/starch copolymer resin.

3. The resin composition of claim 1, wherein the flexibility-imparting agent is polycaprolactone.

4. The resin composition of claim 1, wherein the compatibilizing agent is a poly(L-lactic acid)/poly(butylene succinate) block copolymer resin.
